(19) United States
(12) Patent Application Publication
(10) Pub. No.: US 2003/0044591 A1
(43) Pub. Date: Mar. 6, 2003

(54) Slide-resistant pad

(76) Inventor: Cheng-Che Hsieh, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/939,617

(22) Filed: Aug. 28, 2001

(51) Int. Cl. B32B 3/00

(52) U.S. Cl. 428/212; 428/195

(57) ABSTRACT

A slide-resistant pad includes a first slide-resistant layer, an in-between layer and a second slide-resistant layer combined together by adhering their respective plane surface firmly to form a solid slide-resistant pad. The first slide-resistant layer is transparent and has numerous solid concavo-convex grains on one surface, the in-between layer is printed with resplendent designs and the second slide-resistant layer is transparent or non-transparent and also has numerous solid concavo-convex grains formed on one surface. The slide-resistant pad not only has an effect of aesthetic feeling of stereoscopic vision but has practical value as well.

### BACKGROUND OF THE INVENTION

This invention relates to a slide-resistant pad, particularly to one combined by two transparent layers and an in-between layer with colorful designs, not only having practical value but also an effect of aesthetic feeling of stereoscopic vision.

Conventional slide-resistant pads have been widely used on floors or beneath electric appliances or the like, and a variety of slide-resistant pads are sold on market nowadays, but consumers are most attentive to the styles and materials of the slide-resistant pads they buy. The conventional slide-proof pads are mostly made of special cloth and plastics, having the following disadvantages.

1. A slide-resistant pad made of special cloth is bulky and easy to be soiled, not convenient to be washed off, and easy to have the soiled trace left, thus unable to be used for a long time.

2. A slide-resistant pad made of plastics is formed integral by a mold so it is monotonous in appearance. Some plastic-made slide-resistant pads have their surfaces colored or formed integral into various concavo-convex grains, but a design-processing on the surfaces of such slide-resistant pads is quite difficult and needs to take much time and costs much money, too.

3. Some plastic-made slide-resistant pads have their surfaces adhered with comparatively hard materials with colorful designs on them, still looking monotonous and undistinguished.

### SUMMARY OF THE INVENTION

The objective of this invention is to offer a slide-resistant pad including a first slide-resistant layer transparent and having a great many solid concavo-convex grains on one side surface, an in-between layer having colorful designs printed on it and adhered under the first slide-resistant layer and then a second slide-resistant layer transparent or non-transparent and having numerous solid concavo-convex grains formed on one side surface to be closely pasted under the in-between layer. Thus, the colorful designs of the in-between layer can be seen through the first or the second transparent slide-resistant layer to achieve an effect of aesthetic feeling of stereoscopic vision and a function of practicality.

### BRIEF DESCRIPTION OF THE DRAWINGS

This invention will be better understood by referring to the accompanying drawings, wherein:

FIG. 1 is an exploded perspective view of a slide-resistant pad of the present invention.

FIG. 2 is a cross-sectional view of the slide-resistant pad of the present invention.

FIG. 3 is perspective view of the slide-resistant pad assembled of the present invention.

FIG. 4 is another perspective view of the slide-resistant pad assembled of the present invention.

### DETAILED DESCRIPTION OF THE PREFFERRED EMBODIMENTS

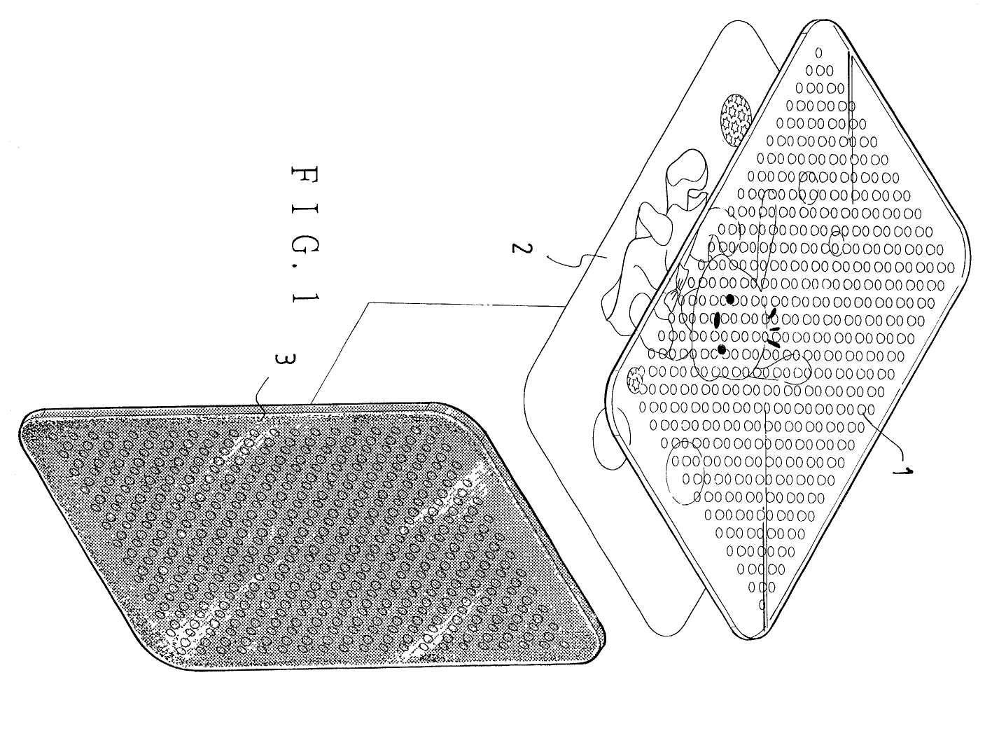

A preferred embodiment of a slide-resistant pad of the present invention, as shown in FIG. 1, includes a first slide-resistant layer 1, an in-between layer 2 and a second slide-resistant layer 3 combined together.

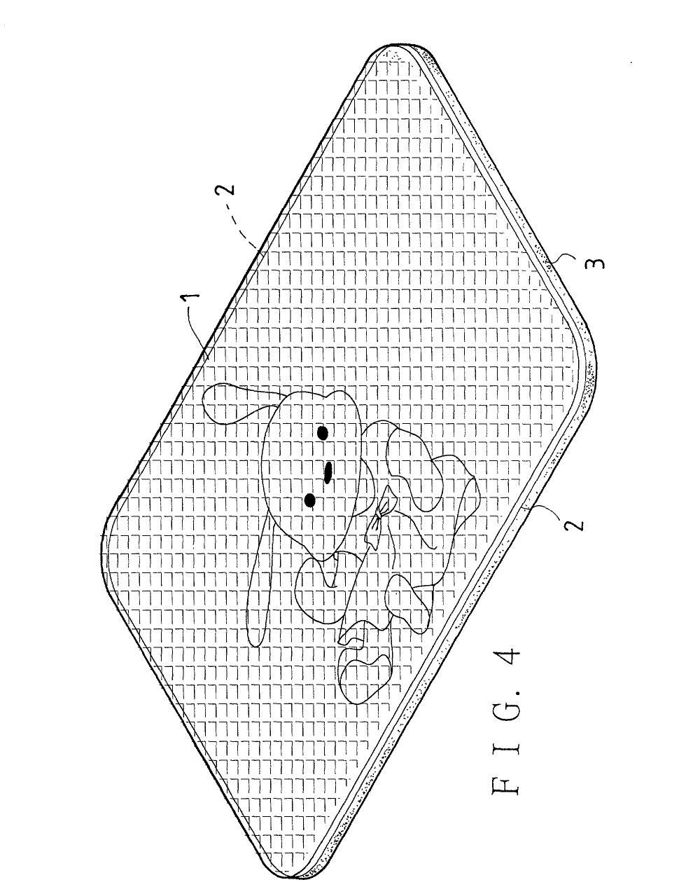

The first slide-resistant layer 1 is a transparent body made of a polymer of ethylene-accetate or polyethylene (PE), having a great number of solid concavo-convex coarse grains formed densely on one surface, as shown in FIG. 4.

The in-between layer 2 is made of thin cloth or film-like strip having colorful designs directly printed or transfer-printed on it.

The second slide-resistant layer 3 is a transparent or non-transparent body made of a polymer of ethylene-accetate or polyethylene (PE) (colored if necessary), with one surface formed with a great many solid concavo-convex coarse grains, just like the first slide-resistant layer 1.

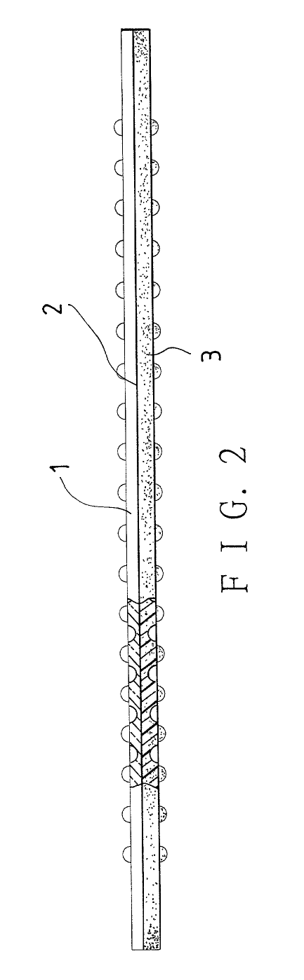

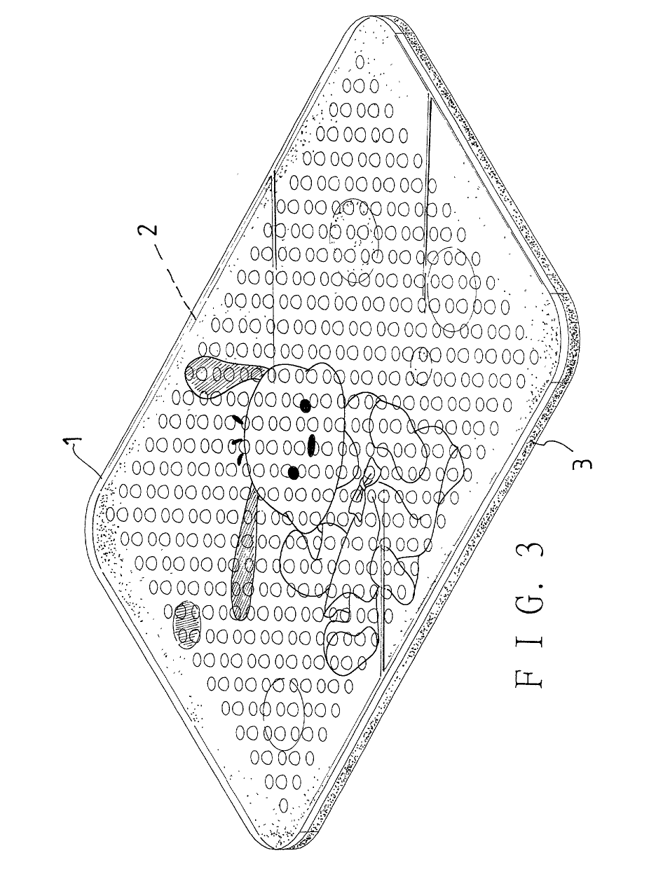

In combining, as shown in FIG. 2 and 3, the first slide-resistant layer 1, the in-between layer 2 and the second slide-resistant layer 3 are combined together by adhering their respective plane surface firmly to form a solid slide-resistant pad. By so designing, the coarse surface or the solid concavo-convex slide-resistant portion of the first and the second layers 1 and 3 function to prevent sliding and the resplendent designs of the in-between layer 2 can be seen through the first or the second transparent slide-resistant layer 1, 3. Therefore, the slide-resistant pad having both an effect of aesthetic feeling of stereoscopic vision and practical value. Besides, the bottom surface of the first or the second slide-resistant layer 1, 3 can be formed with a colorful background to serve for a contrast to increase its visual aesthetic feeling of originality.

In short, the slide-resistant pad of this invention is specially designed not only to get rid of the disadvantages of monotony in appearance and in color of the conventional one but also to increase its aesthetic feeling by providing resplendent designs inside, enhancing practical value of the product.

What is claimed is:

1. A slide-resistant pad comprising,
a first slide-resistant layer being a transparent body made of a polymer of ethylene-accetate or polyethylene (PE), having numerous solid concavo-convex grains formed on a surface;
an in-between layer being a thin strip and having colorful designs printed on it;
a second slide-resistant layer being a transparent body made of a polymer of ethylene-accetate or polyethylene (PE), with a great many solid concavo-convex grains formed on a surface;
said first slide-resistant layer, said in-between layer and said second slide-resistant layer combined together by adhering their respective plane surface tightly to form an entire slide-resistant pad, said solid slide-resistant pad having a proper effect of slide preventing and also having an effect of aesthetic felling of stereoscopic vision due to the resplendent designs on said in-between layer seen through said first or said second slide-resistant layer.

2. The slide-resistant pad as claimed in claim 1, wherein a bottom surface of said first or said second slide-resistant layer is colored in order to increase its colorful visual effect.

3. The slide-resistant pad as claimed in claim 1, wherein a surface of said first or said second slide-resistant layer is formed coarse.

4. The slide-resistant pad as claimed in claim 1, wherein said first or said second slide-resistant layer has a great number of solid projections or recesses formed densely on the surface of one side.

5. The slide-resistant pad as claimed in claim 1, wherein the colorful designs of said in-between layer is directly printed or transfer-printed.
